(19) United States
(12) Patent Application Publication
(10) Pub. No.: US 2022/0058302 A1
(43) Pub. Date: Feb. 24, 2022

(54) Personalized Vehicle Component System

(71) Applicant: Adrian Ramirez, LaMirada, CA (US)

(72) Inventor: Adrian Ramirez, LaMirada, CA (US)

(21) Appl. No.: 17/122,095

(22) Filed: Dec. 15, 2020

Related U.S. Application Data
(60) Provisional application No. 63/067,414, filed on Aug. 19, 2020.

(51) Int. Cl. G06F 30/15; B29C 51/46; B29C 64/393; B05D 1/02

(52) U.S. Cl. CPC G06F 30/15; B29C 51/46; B33Y 50/02; B05D 1/02; B29C 64/393

(57) ABSTRACT

The present invention relates to a customization previewing system for a component for a vehicle, such as a motorcycle. In one embodiment, the system comprises paintable scaled models or prototypes for OEM motorcycle components, such as fenders, fuel tanks, saddlebags and the like. The model prototypes are configured to be between 50 and 80 percent in size of the OEM motorcycle components to enable the owner to accurately preview or visualize a customization job before the same is performed on the actual OEM motorcycle component. Each of the model prototypes is also comprised of a mounting hook for mounting the prototype to a wall or other surface. A spray painter is used to spray the paint, decoration or graphic onto the prototype and change the color thereof based on the preferences of the user.

### CROSS-REFERENCE TO RELATED APPLICATION

The present application claims priority to, and the benefit of, U.S. Provisional Application No. 63/067,414, which was filed on Aug. 19, 2020 and is incorporated herein by reference in its entirety.

### FIELD OF THE INVENTION

The present invention relates generally to the field of accessories or components for motorcycles. More specifically, the present invention relates to a paintable scaled model for motorcycle parts, thereby enabling motorcycle owners to preview a paint job for their bike. The component system and features trim components and accessories, front and rear fender pieces, a gas tank cover, and saddlebags configured at a 75% scale for paint previews. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, customized graphics and paint for motor vehicles, such as motorcycles, bikes, snowmobiles, and automobiles, have gained increasing popularity in recent years, and customized bikes and motorcycles have been in high demand. More specifically, the customization industry adds stylistic and/or structural changes to the ‘standard’ mass-produced machines offered by original equipment manufacturers or OEMs. Customized motorcycles are unique to the users and add a degree of individuality to their vehicles, as well as enhancing the appearance and aesthetics of the vehicle. The appearance of components or accessories for a motorcycle or vehicle, such as motorcycle tanks, fenders, saddlebags, automobile panels, etc., can be customized to add uniqueness and a sense of personalization to the vehicles. The customization may include changes to the color, design, style, material, or other features of the components of the vehicle. In turn, these customizations can differentiate the individual's vehicle in a racing competition or in public areas, indicate membership in an organization, indicate an official status such as a police officer, or simply express the personality or style of the vehicle owner to others.

To customize a motorcycle, the user may order a custom motorcycle from the manufacturer itself and choose a personalized color for the bike, or may hire skilled designers and/or airbrush artists to conceptualize and the paint the desired designs on different portions of the motorcycle. Even if a manufacturer customizes the motorcycle during its initial production, the users may desire to hire a skilled artist to later modify the bike. Unfortunately, the fees for skilled painters and the like and the cost of customized materials is high which makes the process of customization quite expensive, and out of reach for many consumers.

When customizing a color of the vehicle, a user may choose a color from a booklet having a large palate of possible paint shades of customization. The color shade chosen by the user is used for painting the parts, such as fuel tank, saddlebags, fenders, or other components of the motorcycle or vehicle. Users may not be confident while choosing colors for customization, as making a color choice for painting the complete vehicle by merely viewing the booklet is not enough for some users, and users may not be able to preview the customized vehicle in the choice of color they were hoping for. If the user does not like the customized color once it has been changed on the vehicle, the money invested in the customization is for the most part wasted. Booklets having different models with various colors may be available for users, however, it would be difficult to cover all the possible colors in the booklet and hence the numerous individual styles necessary to accommodate a consuming public.

Generally, full size motorcycle model parts can be kept at the shops to allow the users to view the motorcycles in different colors. However, this solution is not feasible, as full-size motorcycle model parts can be bulky and difficult to transport and store, and having to maintain a large inventory of custom painted parts can be expensive for the shop owner, and consume vast amounts of otherwise useable space.

Additionally, color customization of motorcycles can take several days, and the waiting period may be more based on the availability of the skilled artist. Accordingly, the motorcycle or vehicle needs to be left at the garage for customization for a prolonged period of time, thereby causing inconvenience to the users. Further, if the user is not satisfied with the color customization, changes in the customization would require the vehicle to be kept at the garage or shop for an even longer period of time.

Additionally, users often desire to preview the motorcycle with customization features before the final application of the customization, in case the customization does not meet the expectations of the customer for the vehicle. A user having the ability to easily change or modify the customization before it actually occurs would prevent money being wasted on an incorrect or undesirable customization. Unfortunately, the user currently has no ability to visualize how the final product will look post customization.

Therefore, there exists a long felt need in the art for a system that allows a user to visualize the final look of a customized motorcycle or other vehicle before proceeding with the actual customization. Additionally, there is a long felt need in the art for a customized vehicle visualization method and system that is applicable for various different makes and models of vehicles. Moreover, there is a long felt need in the art for a system that reduces the cost and increases user satisfaction with the vehicle customization process. There is also a long felt need in the art for a system that reduces the amount of space and expense required in a customization shop that would otherwise be occupied by various model parts bearing different customized colors. Finally, there is a long felt need in the art for a paint job preview system for motorcycles and other vehicles that is relatively inexpensive to implement, and safe and easy to use.

The subject matter disclosed and claimed herein, in one embodiment thereof, comprises a motorcycle paint model system for previewing painted motorcycle components, such as a front fender, a rear fender, a gas tank cover, saddlebags, etc. Each previewing component is preferably at a 75% scale of the standard size of the components to be decorated for a motorcycle, and each previewing component features a mounting hook to mount the previewing component to a wall for convenient storage when not in use. A paint sprayer is used to paint the preview component in a desired color, and the color can be changed based on a desired brightness and contrast control button on the sprayer. The previewing components are constructed using thermoforming or plastic injection molding, and are preferably comprised of ABS, acrylic, PVC, or any other suitable lightweight material having similar characteristics.

In this manner, the novel personalized vehicle component system for motorcycles or other vehicles of the present invention accomplishes all of the forgoing objectives, and provides a relatively easy, convenient and cost-effective solution to enabling a user to visualize the final look of the customized motor vehicle, such as a bike, motorcycles or the like. The personalized vehicle component system is also user friendly, inasmuch as it is relatively lightweight and easy to both store and handle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a personalized vehicle component system for previewing painted vehicle components, such as motorcycle components. The painted vehicle components may include a front fender, a rear fender, a gas tank cover, saddlebags, and other accessory previewing components. Each previewing component is at about a 75% scale of the standard size of the component used in an actual motorcycle or vehicle, and each previewing component further comprises a mounting hook to mount the previewing component to a wall or other viewing panel. A paint sprayer is used to apply the desired customized color to the preview component, wherein the color may be adjusted during the painting process via a brightness and contrast changing control on the sprayer. The previewing components may be constructed using thermoforming, additive printing or plastic injection manufacturing processes, and relatively lightweight materials such as ABS, acrylic, PVC, or any other suitable material having similar characteristics.

In a further embodiment thereof, the subject matter disclosed and claimed herein comprises a vehicle parts paint previewing system having a user interface, a processor and a memory. The processor causes the system to retrieve motorcycle or vehicle specific information from the memory, such as dimensions of the individual components, the make and model of the vehicle, etc. The user interface displays the shapes and sizes of the various components, and may suggest customizable colors based on user input preferences. The dimensions of the paint previewing components are about 75% of the individual components OEM size, and a paint sprayer in electrical communication with the system paints the components so that the user can preview the painted components before the actual customization on the user's vehicle commences.

In a further embodiment of the present invention, a computer-assisted method for previewing paint models of a motorcycle or other vehicle by a user is disclosed. The method comprises the step of initially placing a request for a paint or graphic application from a user using a handheld device. The handheld device includes at least one processor and at least one non-transitory storage device storing executable code. The at least one processor executes the stored executable code to provide a display for requesting a customization location to provide the preview paint models for a motorcycle or other vehicle. The request includes the motorcycle or vehicle model, year, and other information, as well as the paint color, and the request is wirelessly transmitted from the handheld device to a web server. The web server transmits the request to a computer system at the customization facility. Next, one or more painting preview models are prepared for a paint spray connected to the computer system at the garage or customization location, and a second processor operates the paint sprayer on the physical preview models per the request. The physical preview models are about 75% of the size of the actual components of the motorcycle or other vehicle, thereby providing an accurate representation of what the actual results of the customization will look like. The method concludes with the system notifying the user of the availability of the preview models for inspection.

In a further embodiment of the present invention, an apparatus for providing painted or other personalized motorcycle or vehicle components for preview is disclosed. The apparatus comprises a computing device to receive make and model information about the user's motorcycle or other vehicle to be customized, as well as a paint color preference from the user. A 3D printer is provided and used to manufacture the physical sample components to be painted with the user selected color, wherein the components are in the range of about 65-75% of the size of the actual components. A spray paint device is then used to automatically paint the components manufactured by the 3D printer with the color selected by the user. Finally, after painting and personalization, the physical components are presented to the user for preview and approval before the customization of the actual parts commences.

In a further embodiment of the present invention, a system is provided for previewing painted or other personalized motorcycle or vehicle components. The system is comprised of a mobile device connected to a server. The server has a processor and a memory for storing computer-executable instructions that, when executed by the processor, cause the server to receive a motorcycle or vehicle make and model and a color or customization preference input from a user interface provided on the mobile device. Next, the shape and size of the vehicle accessory, such as a front fender, a rear fender, a gas tank cover, saddlebags, etc., is calculated. A 3D printer is then instructed to manufacture the desired component at a prototype dimension that is less than the actual component size, and a paint sprayer is instructed to paint the manufactured model for preview before making a permanent modification to the actual vehicle component or accessory.

In a still further exemplary embodiment, a system for prototype creation is described and includes a server having a memory, wherein the memory contains information about the make and model of various vehicles. A processor is provided and connected to the server, and the processor receives instructions from a user device and transmits instructions to create a prototype. An additive manufacturing device is provided along with a sprayer for applying one of a color, graphic or decoration to the manufactured prototype. A preview wall is provided for displaying the manufactured and painted prototype created by the system.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic view of one potential embodiment of the personalized vehicle component system of the present invention in accordance with the disclosed architecture;

FIG. 2 illustrates a perspective view of one potential embodiment of the personalized vehicle component system of the present invention in accordance with the disclosed architecture, wherein the preview components shown are scaled down versions of the actual vehicle parts to be customized;

FIG. 3 illustrates a perspective view of one potential embodiment of a preview component of the personalized vehicle component system of the present invention in accordance with the disclosed architecture, wherein the preview component is being spray painted with a user selected color;

FIG. 4 illustrates a perspective view of one potential embodiment of a preview component of the personalized vehicle component system of the present invention in accordance with the disclosed architecture, wherein the preview component is being spray painted with a user selected color and further comprises a customized graphic thereon;

FIG. 5 illustrates a partial perspective view of one potential embodiment of a preview component of the personalized vehicle component system of the present invention in accordance with the disclosed architecture, wherein the preview component is mounted on a wall via a mounting mechanism;

FIG. 6 illustrates a perspective view of one potential embodiment of a plurality of preview components of the personalized vehicle component system of the present invention in accordance with the disclosed architecture, wherein the preview components are mounted to a wall for previewing by a user;

FIG. 7 illustrates a perspective view of one potential embodiment of a front fender preview component of the personalized vehicle component system of the present invention in accordance with the disclosed architecture;

FIG. 8 illustrates a perspective view of one potential embodiment of a fuel tank preview component of the personalized vehicle component system of the present invention in accordance with the disclosed architecture;

FIG. 9 illustrates a perspective view of one potential embodiment of a rear fender preview component of the personalized vehicle component system of the present invention in accordance with the disclosed architecture;

FIG. 10 illustrates a perspective view of one potential embodiment of a saddle bag preview component of the personalized vehicle component system of the present invention in accordance with the disclosed architecture; and

FIG. 11 illustrates a diagrammatic view of one potential embodiment of the personalized vehicle component system of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a vehicle component system that allows a user to preview the look of a customized motorcycle or other vehicle before proceeding with the actual customization, and for a customized vehicle visualization method and system that is applicable for various different makes and models of vehicles. Moreover, there is a long felt need in the art for a system that reduces the cost and increases user satisfaction with the vehicle customization process, and that reduces the amount of space required in a customization shop that would otherwise be occupied by various model parts bearing different customized colors. Finally, there is a long felt need in the art for a paint job preview system for motorcycles and other vehicles that is relatively inexpensive to implement, and safe and easy to use.

The present invention, in one exemplary embodiment, provides a motorcycle paint model component for previewing painted motorcycle components. The paint model component may be manufactured to be a scaled down model of, for example, a front fender, a rear fender, a gas tank cover, saddlebags, or any other paintable component on a vehicle, such as a motorcycle. Additionally, each previewing component features a mounting hook to mount the reduced scale accessory to a wall for viewing or storage. A paint sprayer is used to apply the paint of the desired color to the preview component, and the color may be adjusted based on a brightness and contrast changing control button on the sprayer. The previewing components may be manufactured thermoforming, additive printing or plastic injection manufacturing techniques, and may be comprised of durable, yet lightweight materials such as ABS, acrylic, PVC, or any other material having similar characteristics.

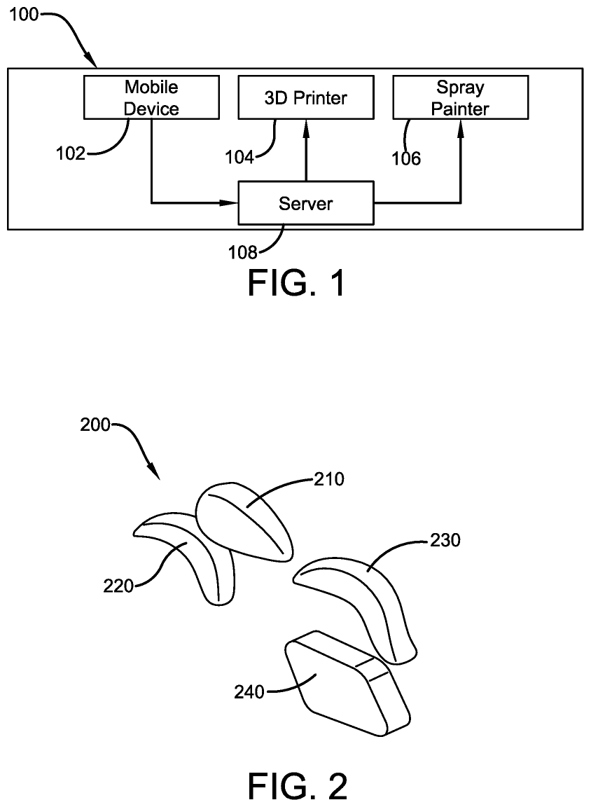

Referring initially to the drawings, FIG. 1 illustrates a diagrammatic view of one potential embodiment of the personalized vehicle component system 100 of the present invention in accordance with the disclosed architecture. More specifically, in one embodiment, the previewing system 100 is comprised of a mobile device 102, such as a handheld portable electronic device, PDA, laptop, tablet, smartphone etc., having a computer implemented application that enables a user (not shown) to send a preview customization job request for a motorcycle or other vehicle component to a server 108. The preview customization job request preferably includes, for example, a motorcycle make and model number, and a color or customization preference with which the preview components are to be painted and/or customized.

Upon receiving the preview customization job request, the server 108 instructs a 3-D printer 104 (or any other suitable manufacturing device, such as a thermoforming unit, an injection molding units, etc.) to manufacture preview motorcycle components, such as a front fender, a rear fender, a gas tank cover, saddlebags and the like. The preview motorcycle components are preferably constructed from a durable, relatively lightweight material including, without limitation, an acrylonitrile butadiene styrene (ABS), acrylic, polyvinyl chloride (PVC), or other suitable material. Each preview motorcycle component further comprises a mounting tab or other mounting structure to enable a user to mount the preview component or model to a wall or other display board.

The size of the preview motorcycle components are preferably in the range of 50-80% of the actual OEM motorcycle parts, and more preferably in the range of 60%-75% to give the user an accurate representation of the results of the customization before it actually occurs and before the user spends what could be a sizeable amount of money on the customization. That way, if changes are needed to the proposed customization to satisfy the user, the same can be made before the customization is performed and the expense of the same is incurred.

Once the preview motorcycle components have been manufactured, the same may be painted. More specifically, a paint sprayer 106 controlled by the server 108 may be used to paint the preview motorcycle components, such as the front fender, rear fender, gas tank cover, saddlebags, etc., produced by the 3D printer 104 with the color chosen by the user in the preview customization job request. Once the paint on the preview motorcycle components is dry and set, the motorcycle components are ready to be previewed by the user. Accordingly, the user previews a paint or other customization job on the preview components before applying it to the actual vehicle or bike. In one embodiment, one or more components of the motorcycle can be chosen by the user for previewing. Also, more than one color, graphic and/or design can be used for previewing the customization.

In one embodiment, the server 108 includes a memory to store software instructions for controlling and instructing, for example, the 3-D printer 104 and the spray painter 106. The memory also stores the user's request(s) for future reference, and information on the make and model types of various vehicles, as well as the various accessories available for such vehicles that may be selected by the user. The server 108 may also include a processor which executes the instructions stored in the memory. The 3-D printer (or other manufacturing means) produces preview components that are heat-resistant, impact-resistant, and flexible enough for snap-fit applications.

FIG. 2 illustrates a perspective view of one potential embodiment of the personalized vehicle component system of the present invention in accordance with the disclosed architecture, wherein the preview components 200 shown are scaled down versions of the actual vehicle parts to be customized. More specifically, the preview components or models 200 are the exact same shape as the actual components of the motorcycle, but only around 75% of the size thereof. The smaller size, combined with the materials used to manufacture the same, makes the preview components 200 relatively lightweight and easier to handle and transport. Further, less paint is required to paint the preview components 200. Nonetheless, by producing components 200 that are approximately three quarters in size to their OEM counterparts, the user can obtain an accurate visualization of what the customization will look like on the actual vehicle when complete, but before spending the time and money necessary to complete the actual customization.

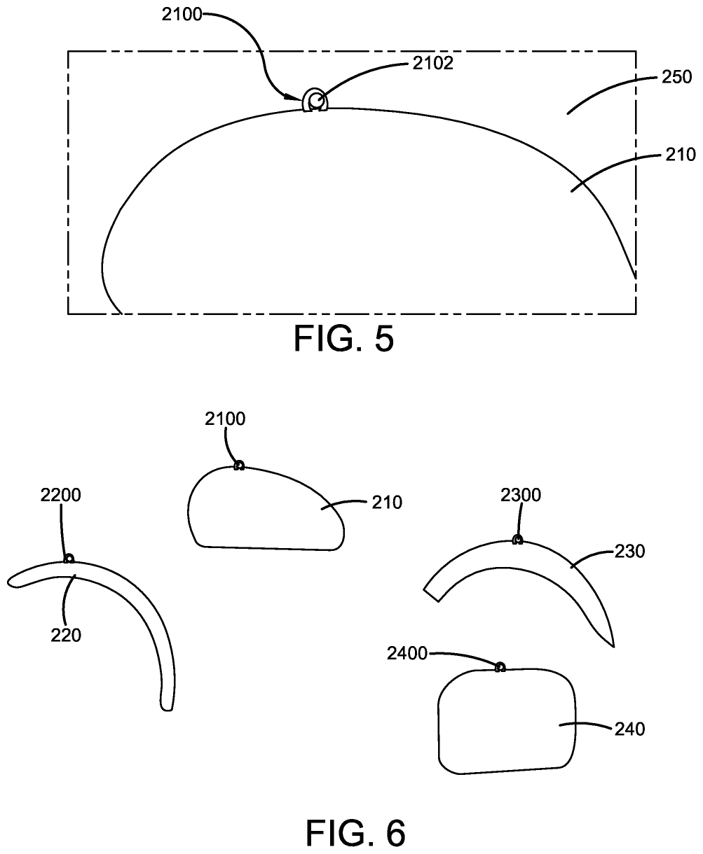

As best shown in FIG. 2, the preview models 200 may include, for example, a fuel tank 210, a front fender 220, a rear fender 230 and a saddlebag 240. However, the invention is not so limited and can be used to produce any paintable or customizable portion of a vehicle, such as a motorcycle. Further, each of the preview models 200 may be constructed using, for example, 3-D printing, a thermoforming machine, plastic injection molding, etc., and may be comprised of a suitable material including, without limitation, an ABS, acrylic, PVC, or any other similar material. Each of the preview models 200 may be painted in one or more colors to preview the appearance of the paint on a standard motorcycle or vehicle. Each of the preview models 210, 220, 230, 240 further comprise a hanging mechanism, as explained more fully below in relation to FIG. 6.

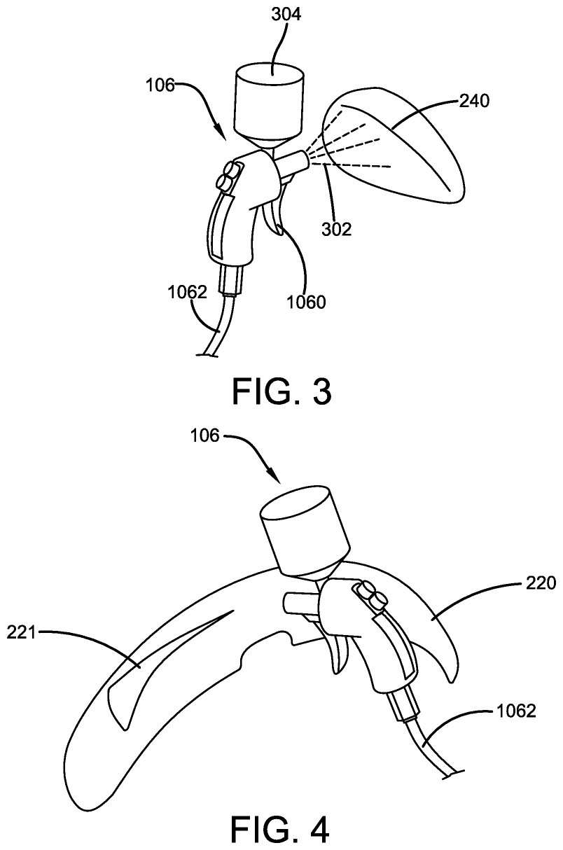

FIG. 3 illustrates a perspective view of one potential embodiment of a preview component in the form of a saddlebag 240 of the personalized vehicle component system of the present invention in accordance with the disclosed architecture, wherein the saddlebag 240 is being spray painted with a paint having a user selected color. More specifically, the spray painter or sprayer 106 is used to spray 302 paint or other decoration onto the saddlebag 240 using a color selected by the user. In this particular embodiment, the spray painter 106 is a manual device which is operated by a user pulling a trigger 1060 to release the paint stored in a reservoir 304 connected to the spray painter 106. However, the spray painter 106 can also be operated through electric power or battery power supplied by an electric wire 1062 or battery pack (not shown). In an alternative embodiment, the spray painter 106 may be automated and/or operated by a robot (not shown) which can be turned on by a server (e.g. server 108) using an instruction received from a processor (not shown).

FIG. 4 illustrates a perspective view of one potential embodiment of a preview component in the form of front fender 220 of the personalized vehicle component system of the present invention in accordance with the disclosed architecture, wherein the front fender 220 is being spray painted and further comprises a customized graphic 221 thereon. More specifically, the spray painter or sprayer 106 is used to paint or decorate the preview component front fender 220 using a color selected by the user. In the embodiment, the spray painter 106 is automatically operated to paint and/or decorate the front fender 220 with, for example, a graphic 221, and is powered by a standard electrical outlet via electric wire 1062.

FIG. 5 illustrates a partial perspective view of one potential embodiment of a preview component in the form of fuel tank 210 of the personalized vehicle component system of the present invention in accordance with the disclosed architecture, wherein the fuel tank 210 is mounted on a wall 250 via a mounting mechanism 2100. More specifically, the fuel tank 210 is formed with a mounting mechanism 2100 attached thereto or protruding outwardly therefrom, in this instance a mounting tab. A nail or other fastener 2102 may be inserted through the mounting tab 2100 and into a surface, such as a wall 250. Notwithstanding, the hanging mechanism 2100 is not limited to a mounting tab, and may be any other suitable mounting means including, without limitation, a wall mounted hook, a clip, a hoop and loop fastener, etc.

FIG. 6 illustrates a perspective view of one potential embodiment of a plurality of preview components 210, 220, 230, 240 of the personalized vehicle component system of the present invention in accordance with the disclosed architecture, wherein the preview components are mounted to a wall 250 for previewing by a user (not shown). More specifically, the fuel tank cover 210 is mounted to the wall 250 via mounting hook 2100, the front fender 220 is mounted to the wall 250 via mounting hook 2200, rear fender 230 is mounted to the wall 250 via mounting hook 2300, and saddlebag 240 is mounted to the wall via mounting hook 2400. As best shown in FIG. 6, the various preview components 210, 220, 230, 240 may be mounted to wall 250 in the general orientation or shape of the overall motorcycle to aid in the user's visualization of the finished customized motorcycle before proceeding with the actual customization.

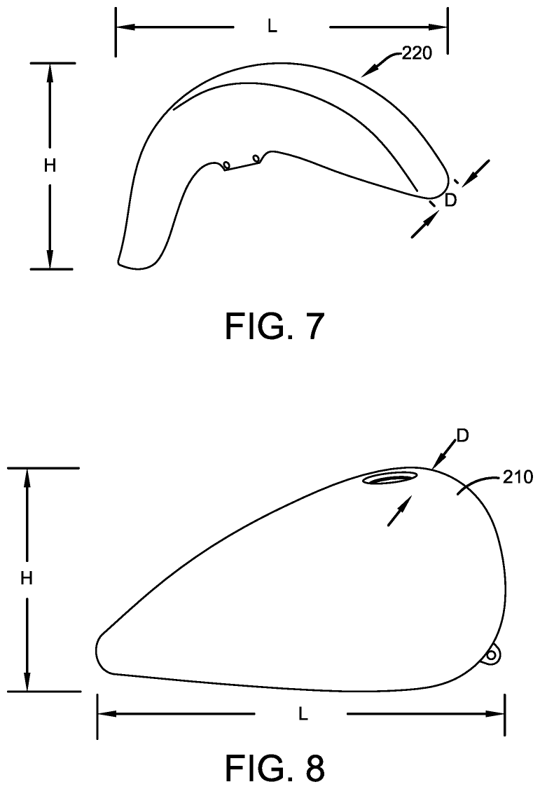

FIG. 7 illustrates a perspective view of one potential embodiment of a front fender preview component 220 of the personalized vehicle component system of the present invention in accordance with the disclosed architecture. As shown as a non-limiting example, the front fender component 220 has dimensions that are less than a standard component or accessory, and in the present example in the range of 75-80% scale of the actual size of a motorcycle front fender for this particular make and model. For example, in one embodiment, the front fender component 220 has a depth D in the range 0.5-1 inch, a height H in the range of 14-18 inches, and a length L in the range of 15-19 inches.

FIG. 8 illustrates a perspective view of one potential embodiment of a fuel tank preview component 210 of the personalized vehicle component system of the present invention in accordance with the disclosed architecture. As shown as a non-limiting example, the fuel tank 210 has dimensions that are less than a standard component or accessory, and in the present example in the range of 75-80% scale of the actual size of a motorcycle fuel tank for this particular make and model. For example, in one embodiment, the fuel tank component 210 has a depth D in the range of 1-2 inches, a height H in the range of 5-6 inches, and a length L in the range of 10-13 inches.

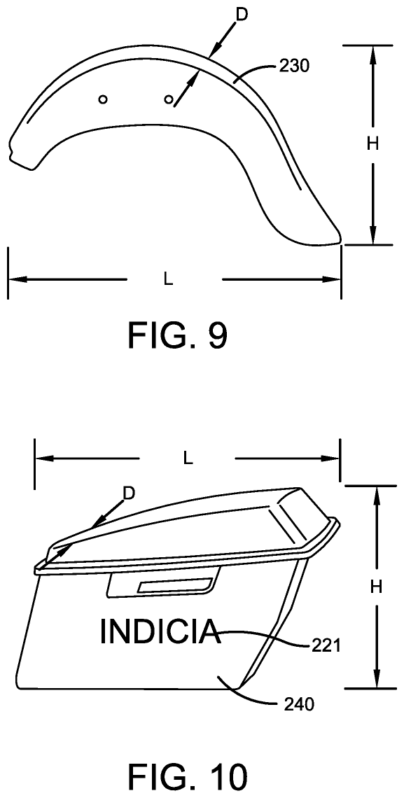

FIG. 9 illustrates a perspective view of one potential embodiment of a rear fender preview component 230 of the personalized vehicle component system of the present invention in accordance with the disclosed architecture. As shown as a non-limiting example, the rear fender 230 has dimensions that are less than a standard component or accessory, and in the present example in the range of 75-80% scale of the actual size of a motorcycle rear fender for this particular make and model. For example, in one embodiment, the rear fender component 230 has a depth D in the range of 0.5-1 inch, a height H in the range of 14-18 inches, and a length L in the range of 15-19 inches.

FIG. 10 illustrates a perspective view of one potential embodiment of a saddle bag preview component 240 of the personalized vehicle component system of the present invention in accordance with the disclosed architecture. As shown as a non-limiting example, the saddlebag 240 has dimensions that are less than a standard component or accessory, and in the present example in the range of 75-80% scale of the actual size of a motorcycle saddlebag for this particular make and model. For example, in one embodiment, the saddlebag component 240 has a depth D in the range of 8-9 inches varying along its length, a height H in the range of 5-11 inches varying along its length, and a length L in the range of 14-23 inches varying along its height. Additionally, the saddlebag component 240, or any of the other preview components 210, 220, 230, may further comprise indicia 221 painted or applied thereto as part of the personalization or customization process.

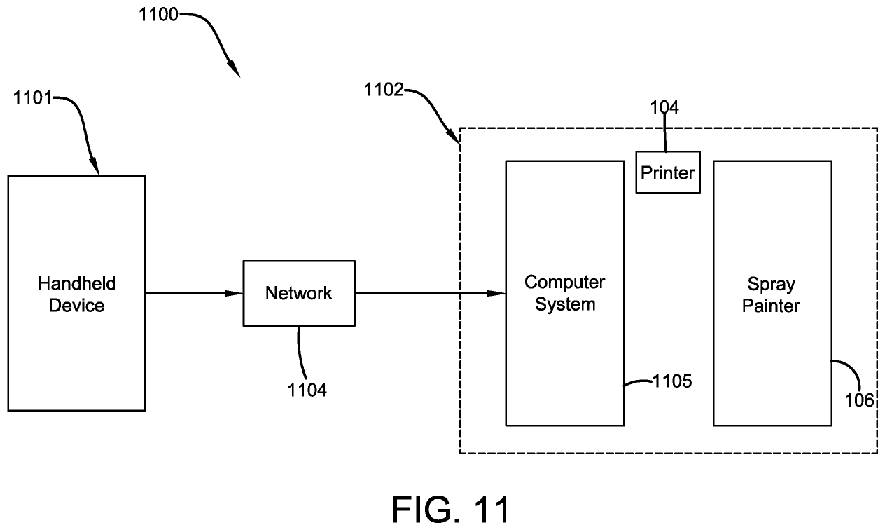

FIG. 11 illustrates a diagrammatic view of one potential embodiment of the personalized vehicle component system 1100 of the present invention in accordance with the disclosed architecture. More specifically, the personalized vehicle component system 1100 comprises a handheld device 1101, a network 1104 and a computer system 1105. The handheld device 1101 can be any of a portable electronic device, a PDA, laptop, smartphone, etc. and is comprised of a computer implemented application that enables a user to send a preview paint job or graphics request for a motorcycle component to a computer system 1105 present at, for example, a garage, customization shop or workshop 1102 through the network 1104, such as the internet or any other private connection (e.g., a VPN).

The preview paint or customization job request includes a motorcycle or vehicle make and model and a color preference with which the preview components are to be painted. Upon receiving the request, the computer system 1105 instructs a 3-D printer 104 (or any other suitable manufacturing device, such as a thermoforming unit, an injection molding unit, etc.) to manufacture the requested preview motorcycle components, such as a front fender, a rear fender, a gas tank cover, saddlebags and the like. Once the preview motorcycle components have been manufactured, the same may be painted. More specifically, a paint sprayer 106 controlled by the computer system 1105 may be used to paint the requested preview motorcycle components.

Once the paint or customization on the preview components is dry and set, the components are ready to be previewed by the user. Accordingly, the user previews a paint or other requested customization job on the preview components before applying it to the actual bike or other vehicle. The user may also see the images of the painted preview components on the handheld device 1101 so that the user can share the images on a social network, or with friends through a messaging application.

In one embodiment, a motorcycle or other vehicle owner or other user may use an electronic ordering system to specify and order customized vehicle preview components, such as those described herein, as part of the process of customizing a vehicle, such as a motorcycle. In particular, a parts supplier, a vehicle manufacturer, OEM, or customizer may provide an electronic ordering system that implements the system of present invention to specify, manufacture, paint and preview one or more components. In another embodiment, once the motorcycle or vehicle owner or other user selects the make and model and, if needed, year of the motorcycle to customize, the system 100, 1100 may render a representative vehicle with highlighted vehicle components indicating the particular components of that vehicle for which preview components need to be shown to the user.

Notwithstanding any of the forgoing, it should be appreciated that the preview components 100, 200 can be presented in a scale identical to the original part or component of the motorcycle, or can be designed and made in a reduced scale compared to the original part. Further, each preview component 100, 200 is a single unitary piece, and can also be configured for headlight fairing or any other related paintable or trim component, accessory or item.

Certain terms are used throughout the description and claims contained herein to refer to particular features or components of the invention. As one skilled in the art will appreciate, different persons may refer to the same feature or component by different names. This document does not intend to distinguish between components or features that differ in name but not structure or function. As used herein “previewing system”, “paint previewing system”, “motorcycle previewing system”, and “scaled motor vehicle models” are interchangeable and refer to the previewing system 100 of the present invention.

Notwithstanding the forgoing, the previewing system 100 of the present invention and its various components can be of any suitable shape, size and configuration as is known in the art without affecting the overall concept of the invention, provided that they accomplish the above stated objectives. One of ordinary skill in the art will appreciate that the size, configuration and material of the previewing system 100 and its various components as shown in the FIGS. are for illustrative purposes only, and that many other sizes, configurations and materials of the previewing system 100 are well within the scope of the present disclosure. Although the dimensions of the previewing system 100 and its various components are important design parameters for user convenience, the previewing system 100 and its various components may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for creating a vehicle component prototype comprising:
a server having a memory containing information relating to a make and model of a selected vehicle;
the memory further comprising a plurality of colors, graphics and other decorations for application to the vehicle component prototype;
a user interface, wherein the user interface is in communication with the server to allow a user to select at least one of the plurality of colors, graphics and other decorations to be applied to the vehicle component prototype; and
a manufacturing means for creating the vehicle prototype of the selected vehicle.

2. The system as recited in claim 1, wherein the user interface is one of a portable electronic device, a PDA, a laptop, a tablet or a smartphone.

3. The system as recited in claim 1, wherein the manufacturing means is one of a 3-D printer, a thermoform machine and an injection molding machine.

4. The system as recited in claim 1, wherein vehicle component prototype is one of a fender, a fuel tank, and a saddle bag.

5. The system as recited in claim 1, wherein the vehicle component prototype further comprises a mounting means.

6. The system as recited in claim 1, wherein the vehicle component prototype is smaller in size than a corresponding vehicle component on the selected vehicle.

7. The system as recited in claim 1, wherein the vehicle component prototype is between 20 and 50 percent smaller in size than a corresponding vehicle component on the selected vehicle.

8. The system as recited in claim 1 further comprising a paint sprayer for applying the at least one of the plurality of colors, graphics and other decorations to the vehicle component prototype.

9. The system as recited in claim 8, wherein the paint sprayer receives instructions from a processor.

10. The system as recited in claim 1, wherein the system includes a processor connected to the server for implementing instructions received from the user.

11. The system as recited in claim 1, wherein the system includes a 3-D printer which receives instructions from the server.

12. The system as recited in claim 1, wherein the vehicle component prototype is comprised of a select one of an ABS, an acrylic, and a PVC.

13. A method for creation of a motorcycle preview component comprising:
selecting a make and a model of an actual motorcycle upon which the motorcycle preview component will be based;
manufacturing the motorcycle preview component to be between 50 and 80% in size of the selected make and model of the actual motorcycle; and
applying at least one of a user selected color, graphic or decoration to the manufactured motorcycle preview component.

14. The method for creation of a motorcycle preview component as recited in claim 13, wherein step of manufacturing the motorcycle preview component is performed by a select one of a 3-D printer, a thermoform machine or an injection molding machine.

15. The method for creation of a motorcycle preview component as recited in claim 13, wherein the motorcycle preview component is comprised of an ABS, an acrylic, or a PVC.

16. The method for creation of a motorcycle preview component as recited in claim 13, wherein the motorcycle preview component comprises a mounting bracket.

17. The method for creation of a motorcycle preview component as recited in claim 13, wherein the motorcycle preview component is one of a fender, a saddlebag or a fuel tank.

18. A system for previewing a component for a vehicle, the system comprising:
a memory comprising a plurality of customization options and a set of information relating to a make and a model of a number of different vehicles;
a processor for accessing the memory and providing a set of instructions to an adaptive manufacturing device to manufacture a prototype of the component; and
a sprayer for applying at least one of a color, a graphic or a decoration to the prototype of the component.

19. The system for previewing a component for a vehicle as recited in claim 18, wherein the prototype is created to be between 60 and 80 percent in size of the component.

20. The system for previewing a component for a vehicle as recited in claim 18, wherein (a) the adaptive manufacturing device is a select one of a 3-D printer, a thermoform machine or an injection molding machine, (b) the prototype is comprised of at least one of an ABS, an acrylic, or a PVC, and (c) the prototype if comprised of a mounting bracket.
